(19) United States
(12) Patent Application Publication
(10) Pub. No.: US 2021/0197466 A1
(43) Pub. Date: Jul. 1, 2021

(54) REFLECTIVE BARRIERS

(71) Applicant: HEWLETT-PACKARD DEVELOPMENT COMPANY, L.P., Spring, TX (US)

(72) Inventor: Arthur H. BARNES, Vancouver, WA (US)

(73) Assignee: HEWLETT-PACKARD DEVELOPMENT COMPANY, L.P., Houston, TX (US)

(21) Appl. No.: 16/077,754

(22) PCT Filed: Apr. 13, 2017
(86) PCT No.: PCT/US2017/027404

§ 371 Date: Aug. 14, 2018

(51) Int. Cl. B29C 64/291; B33Y 30/00; B29C 64/165; B29C 64/295

(52) U.S. Cl. CPC B29C 64/291; B29C 64/295; B29C 64/165; B33Y 30/00

(57) ABSTRACT

Example systems relate to reflective barriers. In some examples, devices utilizing reflective barriers can include a carriage device, comprising an enclosure to encase a plurality of energy sources directed in a particular direction, and a reflective barrier positioned within the enclosure, wherein the reflective barrier comprises a reflective insulation material.

### BACKGROUND

Additive manufacturing techniques, such as three dimensional (3D) printing, can manufacture objects through deposition of successive layers of build material onto a build surface. Build material may be deposited onto the build surface. Portions of the build material may then be selectively solidified, and the process may be repeated until the 3D object is fully manufactured.

### BRIEF DESCRIPTION OF THE DRAWINGS

FIG. 1 is an example system for utilizing reflective barriers consistent with the present disclosure.

FIG. 2 is an example of a system for utilizing reflective barriers consistent with the present disclosure.

FIG. 3 is an example of a system for utilizing reflective barriers consistent with the present disclosure.

### DETAILED DESCRIPTION

A number of systems and devices for reflective barriers are described herein. In some examples, a device utilizing reflective barriers can include a carriage device, comprising an enclosure to encase a plurality of energy sources directed in a particular direction, and a reflective barrier positioned within the enclosure, wherein the reflective barrier comprises a reflective insulation material (e.g., material that reflects a spectrum of wavelengths, material that reflects heat energy, etc.). In some examples, the carriage device can be utilized with a 3D printing device. In some examples, the carriage device can be positioned over a build area and apply energy on the surface of the build area. For example, the carriage device can include a plurality of energy sources (e.g., heating lamps, etc.) to apply heat energy on the surface of the build area.

Additive manufacturing techniques, such as 3D printing, may involve deposition of build material onto the build area. As used herein, a build material refers to a material able to be deposited and selectively solidified to create a 3D object. A build material may be a thermoplastic powder, a powdered metal material, powdered plastic material, powdered resin material, or any other material suitable for use in additive manufacturing. A build area may refer to a portion of a build surface onto which build material is deposited.

In some examples, the build material can be selectively solidified utilizing a 3D printing agent (e.g., fusing agent, printing agent, etc.). The printing agent can, in an example, be a dark colored (e.g., black) thermal absorber and/or a colorless thermal absorber (e.g., Ultraviolet (UV) absorbers). The printing agent can also include energy absorption retarding printing agents and/or a moderating printing agent that modifies a degree of coalescence of the build material. In some examples, the printing agent can be deposited on portions of the build material to solidify the portions with deposited printing agent. In some examples, printing agent can be utilized to increase the temperature of the build material with deposited printing agent compared to the temperature of the build material without deposited printing agent.

In some examples, build material can be a reflective material. The build material can be a reflective material to maintain the temperature of the build material relatively cooler than build material with deposited printing agent. In some examples, the reflective barriers described herein can receive reflected energy from the build material and direct the reflected energy back toward the build area. In some examples, the reflective barriers can direct the reflected energy back toward build material with deposited printing agent. In this way, the reflective barriers described herein can provide additional energy to areas of the build area with relatively smaller quantities of printing agent compared to other areas of the build area with relatively greater quantities of printing agent. In some examples, the areas with relatively greater quantities can correspond to relatively larger objects to be solidified and the areas with relatively smaller quantities can correspond to relatively smaller objects to be solidified.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

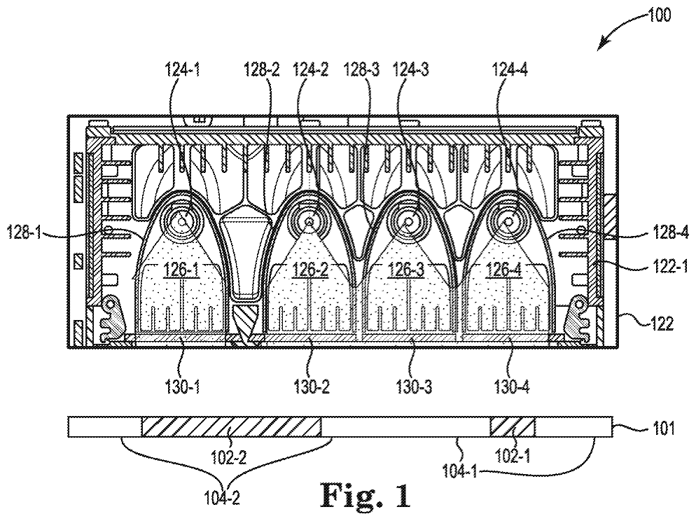

FIG. 1 is an example system 100 for utilizing reflective barriers 128-1, 128-2, 128-3, 128-4 consistent with the present disclosure. In some examples, the system 100 can be utilized for additive manufacturing. For example, the system 100 can be a part of a 3D printing system for generating 3D objects. In some examples, the system 100 can include a build area 101 with build material spread across the build area 101.

In some examples, the build material on the build area 101 can include build material portions 104-1, 104-2 surrounding printing agent portions 102-1, 102-2. As used herein, build material portions 104-1, 104-2 can include portions of the build area 101 with build material with no printing agent deposited on the build material. In some examples, the build material portions 104-1, 104-2 can be portions of the build area 101 that are not solidified into objects as described herein. As used herein, printing agent portions 102-1, 102-2 can include portion of the build area 101 with printing agent deposited on the build material. In some examples, the printing agent portions 102-1, 102-2 can be portions of the build area that are solidified into 3D objects as described herein.

As described herein, the printing agent portions 102-1, 102-2 can be utilized to selectively solidify the build material. In some examples, the printing agent portion 102-1 can include a relatively smaller quantity of printing agent deposited on the build material compared to printing agent portion 102-2. In some examples, a solidified object from the printing agent portion 102-1 can be a relatively smaller object compared to an object solidified from the printing agent portion 102-2.

In some examples, it can take a relatively longer period of time to solidify the printing agent portion 102-1 compared to the printing agent portion 102-2. For example, the printing agent deposited on the printing agent portions 102-1, 102-2 can be the same type of printing agent with similar energy absorption properties. In this example, a relatively small quantity of printing agent can deposited on the printing agent portion 102-1 can take a longer period of time to raise the temperature of the build material compared to larger quantity of printing agent deposited on the printing agent portion 102-2.

In some examples, the quantity of time to raise the temperature of the build material of the printing agent portion 102-1 can have negative effects on the printing agent portion 102-2. For example, the quantity of time to raise the temperature of the build material of the printing agent portion 102-1 can result in excess energy being absorbed by the printing agent portion 102-2. In this example, the excess energy can distort the properties of an object solidified by the printing agent portion 102-2.

In some examples, energy can be provided to the build area 101 via a carriage device 122. In some examples, the carriage device 122 can be an enclosure that can be positioned above the build area 101. The carriage device 122 can be coupled to a system for moving the carriage device 122 above the build area 101. For example, a system can move the carriage device 122 from a first position over the build area to a second position over the build area. In this example, the first position can be on a right side as illustrated in FIG. 1 and the second positon can be on a left side as illustrated in FIG. 1. In this example, a system can move the carriage 122 over the build area 101 from the right of FIG. 1 to the left of FIG. 1 at a particular speed (e.g., distance per unit of time, etc.).

In some examples, the carriage 122 can move over the build area 101 at a particular speed based on a quantity of energy to be delivered to solidify the printing agent portions 102-1, 102-2. For example, the carriage 122 can provide a particular quantity of energy. In this example, when the carriage 122 moves at a relatively slower pace, a greater quantity of energy can be delivered to the build area 101. In this example, when the carriage 122 moves a relatively faster pace, a lower quantity of energy can be delivered to the build area 101.

As described herein, the relatively smaller printing agent portion 102-1 can be provided relatively more energy and/or the carriage 122 may move relatively slower to provide energy for a relatively greater period of time. In some examples, the carriage 122 can move at a constant speed across the build area 101. In these examples, if the carriage 122 has to move relatively slower to provide more energy to the printing agent portion 102-1, then the carriage 122 will also move at the same speed over the printing agent portion 102-2. In this example, the printing agent portion 102-2 may receive too much energy and the solidified object from the printing agent portion 102-2 may include defects due to the energy provided.

In some examples, the carriage 122 can include a plurality of energy sources 124-1, 124-2, 124-3, 1244 to provide energy 126-1, 126-2, 126-3, 126-4. In some examples, the plurality of energy sources 124-1, 124-2, 124-3, 124-4 can be heating lamps or infrared light sources that produce heat energy 126-1, 126-2, 126-3, 126-4 that can be applied to the build area 101. For example, the plurality of energy sources 124-1, 124-2, 124-3, 124-4 can be quartz infrared halogen lamps. In some examples, the plurality of energy sources 124-1, 124-2, 124-3, 124-4 can be directed toward the build area 101.

In some examples, the plurality of energy sources 124-1, 124-2, 124-3, 124-4 can be directed to a corresponding portion 130-1, 130-2, 130-3, 130-4 of the enclosure of the carriage 122. In some examples, the corresponding portions 130-1, 130-2, 130-3, 130-4 can be a transparent material, a filter material, and/or other type of material based on type of printing agent utilized and/or the type of build material utilized. For example, the corresponding portions 130-1, 130-2, 130-3, 130-4 can include a semi-transparent filter to filter out portions of alight spectrum generated by the plurality of energy sources 124-1, 124-2, 124-3, 124-4. As illustrated in FIG. 1, in some examples, the reflective barriers 128-1, 128-2, 128-3, 128-4 can extend from the plurality of energy sources 124-1, 124-2, 124-3, 124-4 to a surface (e.g., portion 130-1, 130-2, 130-3, 130-4) of the enclosure of the carriage 122.

In some examples, the energy source 124-1 can be a “warming lamp” to raise the temperature of the build material of the build area 101 to a first temperature. In some examples, a warming lamp can be a low color temperature lamp that contains a relatively small portion of it's emitted energy in the near infrared part of the spectrum. In some examples, the energy sources 124-2, 124-3, 124-4 can be “fusing lamps” to raise the temperature of the build material of the build area 101 to a second temperature. In some examples, the fusing lamps can be high color temperature lamps (e.g., 2750 Kelvin) that contain a relatively large portion of it's emitted energy in the near infrared part of the spectrum. For example, the energy source 124-1 can raise the temperature of the build material to a temperature that prepares the build material for a fusing process. In this example, the energy sources 124-2, 124-3, 124-4 can raise the temperature of the printing agent portions 102-1, 102-2 above a threshold temperature for fusing the build material of the printing agent portions 102-1, 102-2 to melt and solidify an object from the build material of the printing agent portions 102-1, 102-2.

In some examples, the enclosure 122 can include a number of reflective barriers 128-1, 128-2, 128-3, 128-4. In some examples, the reflective barriers 128-1, 128-2, 128-3, 128-4 can comprise a reflective insulation material that can reflect the energy provided by the plurality of energy sources 124-1, 124-2, 124-3, 124-4 and/or energy reflected by the build material of the build area 101. In some examples, the number of reflective barriers 128-1, 128-2, 128-3, 128-4 can have a relatively high reflectance. For example, the number of reflective barriers 128-1, 128-2, 128-3, 128-4 can have a reflectance that is greater than 0.5 for a wavelength(s) emitted by the plurality of energy sources 124-1, 124-2, 124-3, 124-4. As used herein, a reflectance is a measure of the proportion of light or other radiation striking a surface that is reflected off of the surface.

In some examples, the reflective barriers 128-1, 128-2, 128-3, 128-4 can be coated with a reflective material. For example, the reflective barriers 128-1, 128-2, 128-3, 128-4 can be coated with a laminate polyester film or metalized polyester material to act as a reflective material. In some examples, the reflective barriers 128-1, 128-2, 128-3, 128-4 can comprise a reflective material on an interior portion of the reflective barriers 128-1, 128-2, 128-3, 128-4. For example, the reflective barriers 128-1, 128-2, 128-3, 128-4 can comprise a reflective material on a portion of the reflective barriers 128-1, 128-2, 128-3, 128-4 that are exposed to the energy 126-1, 126-2, 126-3, 126-3 provided by the energy sources 124-1, 124-2, 124-3, 124-4.

In some examples, each of the reflective barriers 128-1, 128-2, 128-3, 128-4 can partially encase each of the plurality of energy sources 124-1, 124-2, 124-3, 124-4. For example, the reflective barrier 128-1 can be positioned above the energy source 124-1 and on each side of the energy source 124-1 to the portion 130-1 of the enclosure of the carriage 122. Thus, in this example, the energy source 124-1 can be enclosed by the reflective barrier 128-1 and the portion 130-1 of the enclosure of the carriage 122. In a similar manner, energy sources 124-2, 124-3, 124-4 can each be enclosed by the corresponding reflective barriers 128-2, 128-3, 128-4 and corresponding portions 130-2, 130-3, 130-4 of the enclosure.

In some examples, the reflective barriers 128-1, 128-2, 128-3, 128-4 can be coupled within the enclosure of the carriage 122 to receive energy reflected by exposed build material (e.g., build material without printing agent, etc.) and direct the reflected energy back toward the build area 101. In some examples, the reflective barriers 128-1, 128-2, 128-3, 128-4 can be positioned between the plurality of energy sources 124-1, 124-2, 124-3, 124-4. For example, a reflective barrier with a reflective surface as described herein can be positioned between energy source 124-2 and energy source 124-3.

As described herein, the system 100 can be utilized to apply relatively more energy to printing agent portion 102-1 than to printing agent portion 102-2. As described herein, areas with relatively larger quantities of printing agent can be damaged due to overheating. In some examples, the system 100 can prevent the overheating utilizing reflective barriers 128-1, 128-2, 128-3, 128-4 to receive energy reflected by the build material and directing the energy toward the areas with relatively smaller quantities of printing agent. The reflective barriers 128-1, 128-2, 128-3, 128-4 can increase the energy provided to the areas with relatively smaller quantities of printing agent and solidify the build material faster than previous systems and methods. Thus, the reflective barriers 128-1, 128-2, 128-3, 128-4 can decrease the energy provided to the areas with relatively larger quantities of printing agent.

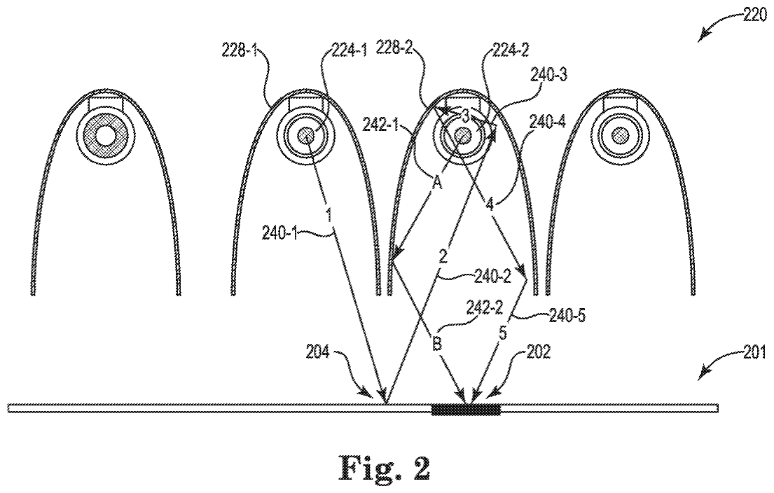

FIG. 2 is an example of a system 220 for utilizing reflective barriers 228-1, 228-2 consistent with the present disclosure. In some examples, the system 220 can be part of a carriage device (e.g., carriage device 122, etc.) as described herein. In some examples, the system 220 can include a build area 201 that can include build material as described herein. In some examples, the build area 201 can include a printing agent portion 202 and a build material portion 204.

As described herein, the printing agent portion 202 can be a portion of the build area 201 that includes build material with printing agent deposited on the build material. As described herein, the build material portion 204 can be a portion of the build area 201 with build material that does not have printing agent deposited on the build material or has reflective printing agent deposited on the build material. For example, the build material portion 204 can include build material that is exposed on the surface of the build area 201. In another example, a reflective printing agent can be applied to the build material portion 204 to lower energy absorption of the build material portion 204.

In some examples, the system 220 can include a plurality of energy sources 224-1, 224-2. In some examples, the plurality of energy sources 224-1, 224-2 can be heating lamps or infrared light sources that produce heat energy (e.g., energy 240-1, 240-2, 240-3, 240-4.240-5, 242-1, 242-2) that can be applied to the build area 201. For example, the plurality of energy sources 224-1, 224-2 can be quartz infrared halogen lamps. In some examples, the plurality of energy sources 224-1, 224-2 can be directed toward the build area 201.

FIG. 2 illustrates energy 242-1, 242-2 transmitted from energy source 224-2. In some examples, energy 242-1, 242-2 can be heat energy and/or infrared light that is generated by the energy source 224-2. In some examples, each of the reflective barriers 228-1, 228-2 can partially encase (e.g., surround, etc.) each of the plurality of energy sources 224-1, 224-2. The number of reflective barriers 228-1, 228-2 can have a reflectance that is greater than 0.5 for a wavelength emitted by the plurality of energy sources 224-1, 224-2.

In some examples, the reflective barriers 228-1, 228-2 can be utilized to direct the energy generated by the energy sources 224-1, 224-2 on to the build area 201. For example, energy 242-1 can be generated by energy source 224-2. In this example, the energy 242-1 can be directed by the reflective barrier 228-2 and transmit from the reflective barrier 228-2 as energy 242-2. In some examples, the directed energy 242-2 can be directed toward the printing agent portion 202 of the build area 201.

In some examples, the reflective barriers 228-1, 228-2 can receive energy reflected from a first area of a build material (e.g., build material portion 204) and direct the reflected energy back to a second area of the build material (e.g., printing agent portion 202, etc.). In some examples, the reflective barriers 228-1, 228-2 can be utilized to receive energy reflected by the build material portion 204 and direct the reflected energy to the printing agent portion 202. For example, energy source 224-1 can transmit energy 240-1 toward the build area 201. In this example, the energy 240-1 can hit the build material portion 204 of the build area 201. In this example, energy 240-2 can be reflected by the build material portion 204 as described herein. In this example, the energy 240-2 can hit a first portion of the reflective barrier 228-2 and be directed as energy 240-3. In this example, the energy 240-3 can hit a second portion of the reflective barrier 228-2 and be directed as energy 240-4. In this example, the energy 240-4 can hit a third portion of the reflective barrier 228-2 and be directed as energy 240-5 that can hit the printing agent portion 202 of the build area 201.

In some examples, the energy 240-2 reflected by the build material portion 204 can be proportional to a surface area of the build material portion 204 compared to the surface area of the printing agent portion 202. For example, a relatively larger surface area of the build material portion 204 can increase a quantity of energy 240-2 that is reflected compared to a relatively smaller surface area of the build material portion 204. The proportional energy 240-2 can provide relatively greater energy to portions of the build area 201 that have relatively smaller printing agent portions 202.

As described herein, the portions of the build area 201 that have relatively smaller printing agent portions 202 may be difficult to maintain a temperature above the melting point since relatively larger printing agent portions can cool at a slower rate compared to the smaller printing agent portions 202. For example, relatively larger printing agent portions can cool more slowly due to a smaller surface to volume ration compared to the smaller printing agent portions 202. In order to keep small printing agent portion 202 temperatures above the melt temperature longer, it can be helpful to heat them to a relatively higher temperature.

If the amount of energy to fuse a relatively larger printing agent portion or relatively larger object was applied to a small printing agent portion 202, the small printing agent portion or object formed from the small printing agent portion 202 could be under fused. If the amount of energy applied to fuse a small printing agent portion 202 was applied to a large printing agent portion it could be overheated. Thus, relatively more energy going in to small printing agent portions 202 can keep them above a melting point long enough for good fusion without applying too much to the large printing agent portions and causing them to melt into the surrounding powder. By increasing the quantity of energy provided to portions of the build area 201 that relatively smaller printing agent portions 202, the system 220 can prevent relatively larger printing agent portions (not illustrated) from being damaged to due overheating as described herein.

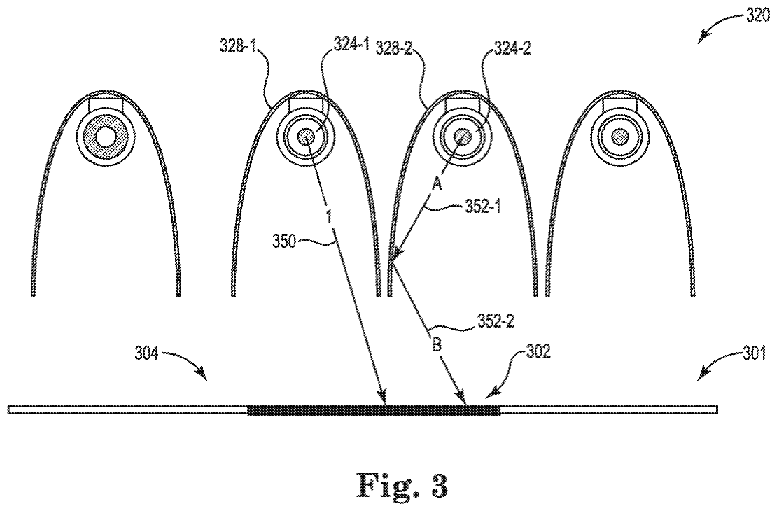

FIG. 3 is an example of a system 320 for utilizing reflective barriers 328-1, 328-2 consistent with the present disclosure. In some examples, the system 320 can be part of a carriage device (e.g., carriage device 122, etc.) as described herein. In some examples, the system 320 can include a build area 301 that can include build material as described herein. In some examples, the build area 301 can include a printing agent portion 302 and a build material portion 304. The system 320 can be the same or similar as system 220 as referenced in FIG. 2. However, the printing agent portion 302 is larger than the printing agent portion 202 as referenced in FIG. 2.

As described herein, the printing agent portion 302 can be a portion of the build area 301 that includes build material with printing agent deposited on the build material. As described herein, the build material portion 304 can be a portion of the build area 301 with build material that does not have printing agent deposited on the build material or has reflective printing agent deposited on the build material. For example, the build material portion 304 can include build material that is exposed on the surface of the build area 301. In another example, a reflective printing agent can be applied to the build material portion 304 to lower energy absorption of the build material portion 304.

In some examples, the system 320 can include a plurality of energy sources 324-1, 324-2. In some examples, the plurality of energy sources 324-1, 324-2 can be heating lamps or infrared light sources that produce heat energy (e.g., energy 350, 352-1, 352-2) that can be applied to the build area 301. For example, the plurality of energy sources 324-1, 324-2 can be quartz infrared halogen lamps. In some examples, the plurality of energy sources 324-1, 324-2 can be directed toward the build area 301.

FIG. 3 illustrates energy 350 transmitted from energy source 324-1. In some examples, energy 350 can be heat energy and/or infrared light that is generated by the energy source 324-1. In some examples, each of the reflective barriers 328-1, 328-2 can partially encase (e.g., surround, etc.) each of the plurality of energy sources 324-1.324-2. The number of reflective barriers 328-1, 328-2 can have a reflectance that is greater than 0.5 for a wavelength emitted by the plurality of energy sources 324-1, 324-2.

In some examples, the reflective barriers 328-1, 328-2 can be utilized to direct the energy generated by the energy sources 324-1, 324-2 on to the build area 301. For example, energy 352-1 can be generated by energy source 324-2. In this example, the energy 352-1 can be directed by the reflective barrier 328-2 and be directed by the reflective barrier 328-2 as energy 352-2. In some examples, the directed energy 352-2 can be directed toward the printing agent portion 302 of the build area 301.

In some examples, the reflective barriers 328-1, 328-2 can be utilized to receive energy reflected by the build material portion 304 and direct the reflected energy to the printing agent portion 302. However, FIG. 3 illustrates that printing agent portions 302 that are relatively large may have little to no reflected energy since the printing agent can be designed to absorb energy. In this way, less energy is reflected by the build material portion 304 and less energy is directed back to the printing agent portion 302. In these examples, the relatively smaller printing agent portions (e.g., printing agent portion 202 as illustrated in FIG. 2, etc.) can receive a greater quantity of energy compared to the larger printing agent portion 302.

As described herein, the energy reflected by the build material portion 304 can be proportional to a surface area of the build material portion 304 compared to the surface area of the printing agent portion 302. For example, a relatively larger surface area of the printing agent portion 302 can decrease a quantity of energy that is reflected compared to a relatively larger surface area of the build material portion 304. The proportional energy can provide relatively less energy to portions of the build area 301 that have relatively larger printing agent portions 302.

As described herein, the portions of the build area 301 that have relatively larger printing agent portions 302 may take less time to reach a melting point of the build material and/or a temperature to solidify the printing agent portion 302. In addition, the larger printing agent portions 302 can take more time to cool compared to smaller printing agent portions. By decreasing the quantity of energy reflected by the surface of the build area 301, the system 320 can prevent relatively larger printing agent portions 302 from being damaged to due overheating as described herein.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to any number of such elements and/or features.

What is claimed:

1. A carriage device, comprising:
an enclosure to encase a plurality of energy sources directed in a particular direction; and
a reflective barrier positioned within the enclosure, wherein the reflective barrier comprises a reflective insulation material.

2. The carriage device of claim 1, wherein the reflective barrier receives energy reflected from a build material and directs reflected energy back to the build material.

3. The carriage device of claim 1, wherein the reflective barrier receives energy reflected from a first area of a build material and directs the reflected energy back to a second area of the build material.

4. The carriage device of claim 3, wherein the first area comprises less three dimensional (3D) printing agent compared to the second area.

5. The carriage device of claim 1, wherein the reflective barrier has a reflectance that is greater than 0.5 for a wavelength emitted by the plurality of energy sources.

6. A system, comprising:
a build area comprising build material, wherein a first portion of the build area has a three dimensional (3D) printing agent deposited on the build material and a second portion of the build area that is free of the 3D printing agent;
a carriage comprising a plurality of energy sources directed toward the build area;
a reflective barrier positioned between the plurality of energy sources to receive reflected energy from the second portion of the build area and direct reflected energy to the first portion of the build area.

7. The system of claim 6, wherein the carriage comprises an enclosure that encases the plurality of energy sources and the reflective barrier.

8. The system of claim 7, wherein the reflective barrier extends from the plurality of energy sources to a surface of the enclosure.

9. The system of claim 8, wherein the surface of the enclosure is a transparent material.

10. The system of claim 6, wherein:
the reflective barrier is positioned between a first heat source from the plurality of energy sources and a second energy source from the plurality of energy sources;
the first energy source provides energy that is reflected by the second portion of the build area and the reflective barrier directs the received reflected energy to the first portion of the build area; and
the second energy source provides energy to the first portion of the build area.

11. A three dimensional (3D) printing device, comprising:
a build area comprising build material, wherein a first portion of the build area has a fusing agent deposited on the build material and a second portion of the build area has less fusing agent compared to the first portion;
a carriage comprising a plurality of heat lamps directed toward the build area;
a plurality of reflective barriers that correspond to each of the plurality of heat lamps to receive reflected energy from the second portion of the build area and direct reflected energy to the first portion of the build area, wherein the plurality of reflective barriers surround an area within the carriage to separate each of the plurality of heat lamps.

12. The 3D printing device of claim 11, wherein energy from a first heat lamp of the plurality of heat lamps provides energy that is reflected by the second portion of the build area and a reflective barrier of the plurality of reflective barriers corresponding to a second heat lamp directs the energy reflected by the second portion of the build area to the first portion of the build area.

13. The 3D printing device of claim 12, wherein the second heat lamp is directed toward the first portion of the build area.

14. The 3D printing device of claim 12, wherein the first heat lamp is directed toward the second portion of the build area.

15. The 3D printing device of claim 11, wherein the second portion of the build area is generating a smaller object compared to the first portion of the build area.
